(19) United States
(12) Patent Application Publication
(10) Pub. No.: US 2012/0111362 A1
(43) Pub. Date: May 10, 2012

(54) FLOOR CLEANING MACHINE

(75) Inventor: Christopher Robert Duncan, Chard (GB)

(73) Assignee: NUMATIC INTERNATIONAL LIMITED, Chamberley (GB)

(21) Appl. No.: 13/384,426

(22) PCT Filed: Jul. 2, 2010
(86) PCT No.: PCT/GB10/01280

§ 371 Date: Jan. 17, 2012

(30) Foreign Application Priority Data
Jul. 17, 2009 (GB) 0912496.7

(51) Int. Cl. A47L 11/40; B08B 1/00

(52) U.S. Cl. 134/6; 15/98

(57) ABSTRACT

A floor cleaning machine is described having a first drive head and a second drive head which are both pivotally mounted to a deck. The first and second drive heads are connected together with a link rod. The cleaning width of the cleaning machine can be changed by pivoting the first drive head about a pivot point on the deck. The pivoting movement of the first drive head causes a movement of the second drive head, via the link rod, in order to provide a new separation for the drive heads.

The present invention relates to a machine for cleaning a floor, and a method of operating the same. In particular, the invention relates to a machine having a plurality of drive heads for connection to respective cleaning heads. A floor is cleaned when the cleaning heads rotate and are passed over the floor surface.

Machines for cleaning floors typically have a number of rotatable cleaning heads that scrub, clean, or polish a floor. Wet cleaning may be possible when a liquid detergent is distributed from a reservoir in the machine and onto the floor in advance of the cleaning heads.

Machines used for contract or commercial cleaning of large floor areas typically have a cleaning path width that is designed for a particular role. For example, a machine intended to clean school corridors may have a narrow path width dictated by door widths, whereas a machine for cleaning a sports arena may have a wider path width. An end user may find that a machine that was bought for one contract is the wrong size for another contract. For example, a machine that was bought for a contract with a supermarket with narrow aisles may be unsuitable for a supermarket with wide aisles.

There is therefore a need for a floor cleaning machine that has a variable cleaning width. One such machine is described in WO 2009/004320 in which outer cleaning heads are pivotally connected to a central cleaning head. The outer cleaning heads can splay outwardly to widen the cleaning path of the machine. Each cleaning head is movable independently of the others.

While the machine described in WO 2009/004320 is suitable for its purpose, there is a need for a floor cleaning machine with a variable cleaning width that can be configured more easily and quickly.

Another floor cleaning machine with a variable cleaning width is described in U.S. Pat. No. 5,524,320. This document describes an arrangement with a large fixed cleaning head and two smaller cleaning heads which are independently moveable. The smaller cleaning heads can retract to avoid an obstacle.

A further floor cleaning machine is described in EP 0 945 551. In this document a parallelogram cleaning head arrangement is described with two fixed cleaning heads and two cleaning heads that can be adjusted independently of one another in order to avoid obstacles.

A yet further floor cleaning machine is described in FR 2 657 769. This document describes an arrangement with three fixed cleaning heads and two cleaning heads that can be pivoted inwardly independently of one another to reduce the overall width of the machine.

According to the present invention there is provided a machine for cleaning a floor, comprising: a deck for supporting at least two drive heads, wherein each drive head comprises a mounting for the attachment of an associated cleaning head and wherein the at least two drive heads are movable with respect to one another and with respect to the deck so as to permit relative movement of the drive heads from a first configuration in which the cleaning head mountings have a first spacing to a second configuration in which the cleaning head mountings have a second spacing; and a link for connecting the drive heads, wherein the link controls relative movement of the drive heads such that a movement of one drive head with respect to the deck causes a movement of at least one other drive head with respect to the deck so as to effect movement of the cleaning head mountings from the first configuration to the second configuration.

In this way the machine can be configured easily to have a plurality of cleaning widths. This can be achieved because the positions of several linked drive heads may be changed by applying a moving force to a single drive head and/or to the link. By moving a drive head the user may be able to change the position of the mounting for the attachment of an associated cleaning head so that the position of a connected cleaning head can be changed.

The link controls relative movement of the drive heads because a movement of one drive head with respect to the deck causes a movement of the link which in turn causes a movement another drive head with respect to the deck. In this way the link controls relative movement of the drive heads from the first configuration to the second configuration. Preferably, the linked connection of drive heads means that the movement of one drive head is dependent on the movement of a connected drive head; following this logic, preferably, the location of the drive head mountings cannot be moved independently of one another, with respect to the deck.

The machine may have a preferred cleaning direction. A cleaning width may be defined as the combined span of the cleaning heads in a direction which is perpendicular to the cleaning direction. The relative movement of the drive heads is preferably designed to change the cleaning width presented by the machine. This may be achieved in part by changing the separation of the cleaning head mountings in a direction that is perpendicular to the cleaning direction, and in part by replacing the cleaning heads.

Preferably each drive head is pivotal with respect to the deck. For example, each drive head may be pivotally mounted on the deck. Thus, the pivoting of one drive head may cause the pivoting of another drive head via the link. This may provide an elegant mechanism for transferring the pivotal movement of one drive head to another drive head via the link. It may also provide a convenient method of assembly by attaching the drive heads to the deck at pivot points. In a particularly preferred embodiment each drive head may act as a swinging arm which carries the cleaning head mounting so that each mounting is capable of travel along a swinging arc.

Preferably the arc radius between a pivot point on the deck and the cleaning head mounting is different for at least two of the drive heads. Thus, an equal angular displacement of the two drive heads may cause an unequal translational displacement of the two cleaning heads. This may be useful in altering the cleaning width of the machine.

The link may connect the at least two drive heads together such that a pivotal or swinging movement of one drive head causes a different magnitude of pivotal movement of another drive head. In this way, there may be a mechanical advantage when the drive heads are connected by the link. Thus, a small swinging movement of one drive head may be transferred into a relatively large swinging movement of another drive head because of the arrangement of the link. This may be achieved by connecting the link to each drive head at a different distance from the respective deck pivot points. The link may be connected to one drive head at a location that is between the pivot point of the drive head on the deck and the cleaning head mounting. The link may be connected to another drive head at a location that is beyond the arc radius of the cleaning head mounting with respect to the pivot point on the deck.

The link may be pivotally mounted on at least one of the drive head, and preferably the link is pivotally mounted on each of the drive heads. In an alternative arrangement the link may comprise a cable that connects the drive heads together. The cable may be arranged in a pulley system so that relative movement of the drive heads is controlled. The link may also be hydraulic, and it may comprise gears or eccentrics for controlling the movement of the drive heads.

Preferably each drive head is pivotally connected to the deck and the link is pivotally connected to each of the drive heads. The arc radius between the pivot point of the link on a drive head and the pivot point of the drive head on the deck may be different for at least two of the drive heads. This may mean that a pivotal movement of a first drive head with respect to the deck causes a different magnitude of pivotal movement for a second drive head with respect to the deck.

The deck may comprise a guide for guiding movement of a drive head with respect to the deck. Thus, the guide and the link together may control movement of a drive head relative to the deck. In use the drive head may be horizontally translational relative to the deck and preferably the guide and/or the link constrain the movement of the drive head to the horizontal so that no vertical movement is possible.

Preferably the guide is provided as a rail or slot on the deck such that the drive head may engage with the rail or slot. The rail or slot may be arcuate to support a pivotal movement of a drive head relative to the deck. Alternatively any shape of rail or slot may be provided to enable any type of movement of a drive head relative to the deck.

It may be preferable to use the machine to clean a floor with the drive heads locked in position. Thus, each drive head may be releasably lockable in position relative to the deck. In this way, the machine may have a fixed cleaning width, in use.

Preferably the deck has a high structural rigidity so that the drive heads can be locked in position effectively. For example, the deck may be cast from aluminium.

Any number of locking means may be appropriate. For example, where the drive heads are pivotally mounted on the deck there may be a number of holes in the deck that align with a hole in the drive head at different positions; in this way, a rod may be able to lock the drive head in position by insertion through respective holes when they are in alignment. In another example, a cam may be turned so as to force the drive heads into tight engagement with the deck thereby to lock the drive heads in position with a friction fit.

Each drive head may be lockable in a plurality of discrete positions. For instance, there may be two positions that each drive head can be locked in. Thus, the machine may be able to present at least two cleaning widths.

The machine may include a pin that is biased towards a detent in the deck or in at least one drive head such that the drive head is releasably locked in position when the pin is received in the detent. Preferably the pin is carried by a drive head and the detent is in the deck. This may be a particularly convenient mechanism for locking the drive head in position relative to the deck. The detent may be provided in a rail or slot of the deck so that the pin automatically fits in the detent when it slides across it. A similar effect may be provided with a detent in the drive head and a plurality of biased pins at different positions on the deck.

Preferably each drive head is movable by hand and the locking means are operable by hand. However, it would be possible for either of these actions to be controlled by electrical or other actuators.

Preferably the machine includes a plurality of cleaning heads, each cleaning head operatively connected to a respective mounting on a drive head. Preferably each cleaning head is removable and replaceable by a cleaning head with a different diameter.

Preferably the cleaning heads are arranged to sweep a continuous cleaning line in a direction that is perpendicular to the direction of travel of the machine. There may be a degree of overlap between the cleaning widths of the respective cleaning heads.

Preferably the machine includes two drive heads only. However, the machine may include any number of drive heads.

One drive head may be provided in advance of another drive head with respect to the preferred direction of cleaning. This may be desirable so that the cleaning heads can sweep a continuous cleaning line in a direction that is perpendicular to the preferred direction of travel without interfering with one another. A small degree of overlap may be provided between the cleaning widths of the respective cleaning heads, but there may be no interference between them because one drive head is provided in advance of another.

Each drive head may further comprise a motor and gear means for transferring the rotation of the motor to a rotatable spindle for connection to a cleaning head. The motor may be mounted in any orientation with respect to the gear means. Where the axis of rotation of the motor is horizontal in use, a worm wheel may be provided to connect the motor to the rotatable spindle which has a vertical axis of rotation, in use.

Preferably the machine further comprises an adjustable splash guard that is movable from a first configuration to a second configuration. In this way the splash guard can be arranged in close proximity to the cleaning heads when they have a first spacing and when they have a second spacing. This can minimise the effect of splash from the rotating cleaning heads.

Preferably the adjustable splash guard is connected to at least one of the link and a drive head so that the splash guard is moved from its first configuration to its second configuration when the drive heads are moved with respect to the deck. Thus, the splash guard may be moved automatically whenever the drive heads are moved to a new configuration.

Preferably the adjustable splash guard is pivotally connected to a drive head. In this way the splash guard can move with respect to the deck in order to accommodate a new drive head position, and it can move with respect to the drive head in order to accommodate a new size of cleaning head.

The movement of the adjustable splash guard may be guided by guiding means on the deck. For example, the deck may include a pin which is received in a slot on the adjustable splash guard, and the pin may slide in the slot in order to define the limits of the splash guard's movement. Of course, the guiding means on the deck may be a slot and the associated pin may be on the adjustable splash guard. By providing guide means on the deck it may be possible to move the splash guard automatically from one configuration to another when the drive heads move relative to the deck.

Preferably the movement of the adjustable splash guard is also guided by guiding means such as a pin or a slot on one of the drive heads.

According to the present invention there is provided a method of operating a machine as previously defined comprising the step of moving one drive head with respect to the deck to cause movement of at least one other drive head with respect to the deck so that the cleaning head mountings are moved from the first configuration to the second configuration.

The method may comprise the further steps of: removing a first cleaning head from a drive head; and attaching a second cleaning head to the drive head, wherein the second cleaning head and the first cleaning head have different diameters.

Thus, the drive heads may be moved into different positions with respect to the deck so that they can support cleaning heads with different diameters. Once original cleaning heads have been replaced with new cleaning heads the machine may provide a different cleaning width.

Any apparatus features may be provided as method features and vice-versa.

In order that the invention may be more readily understood, reference will now be made, by way of example, to the drawings, in which:

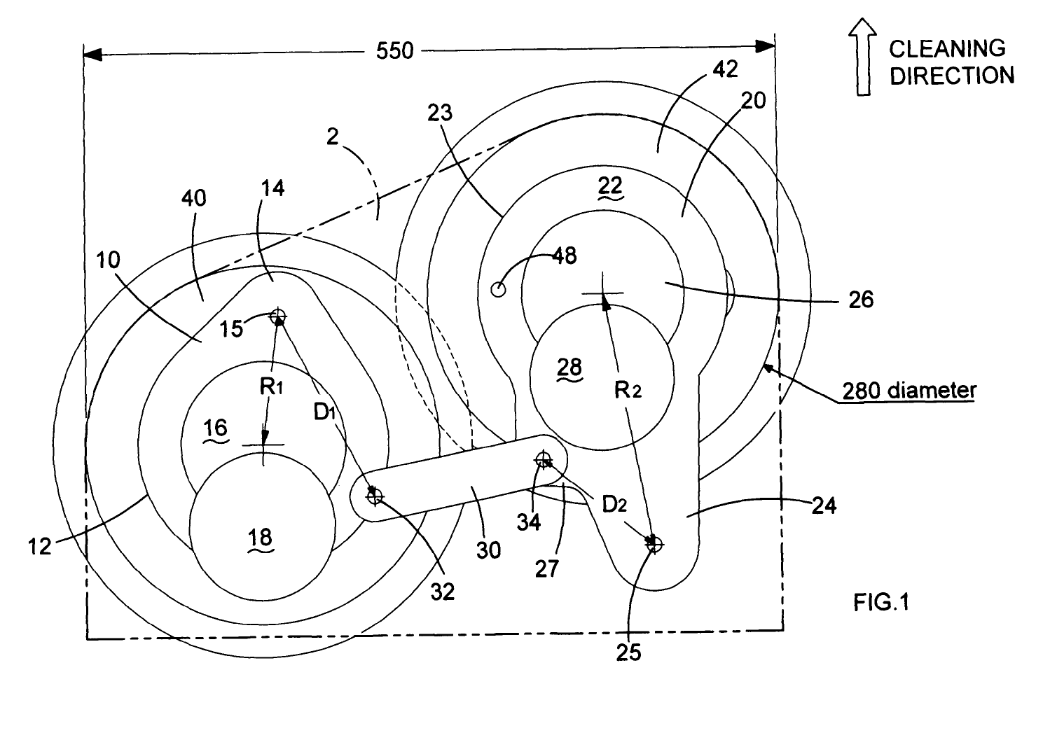

FIG. 1 is a plan view of a cleaning machine in an embodiment of the present invention;

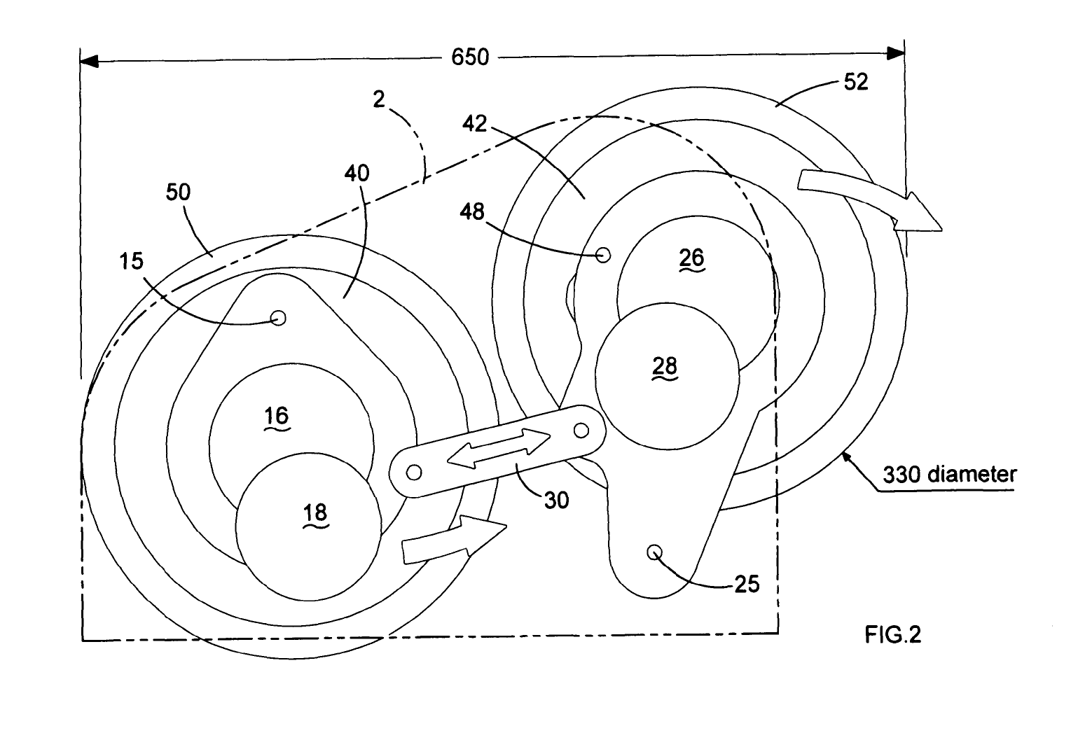

FIG. 2 is a plan view of the cleaning machine of FIG. 1 in a different configuration;

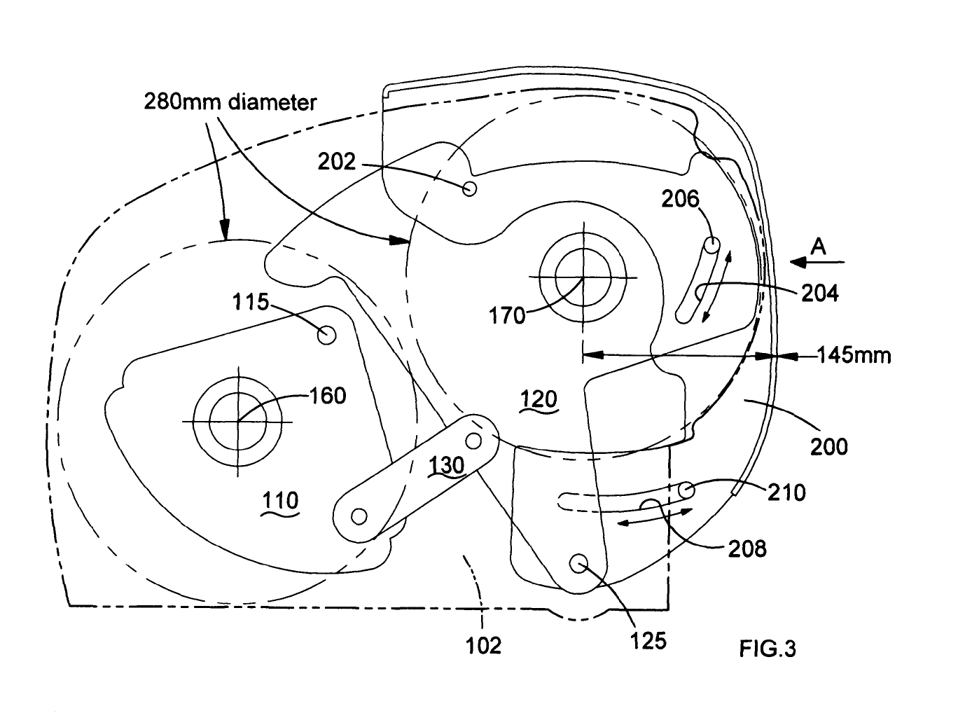

FIG. 3 is a plan view of a cleaning machine in a second embodiment of the present invention;

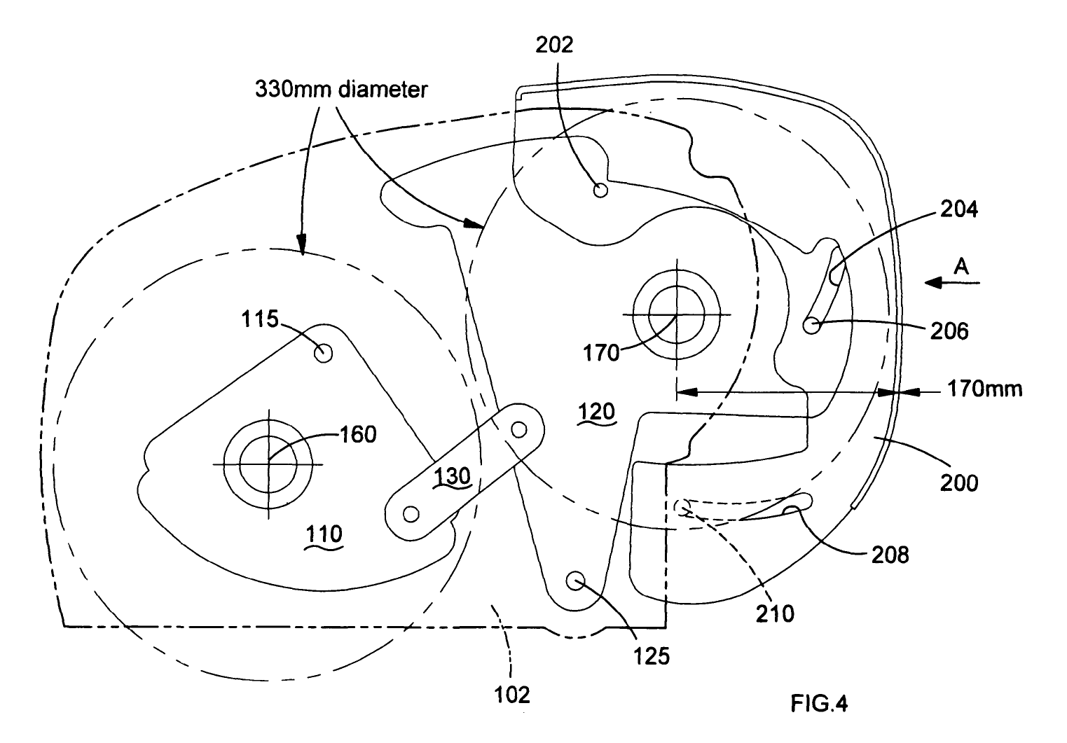

FIG. 4 is a plan view of the cleaning machine of FIG. 3 in a different configuration;

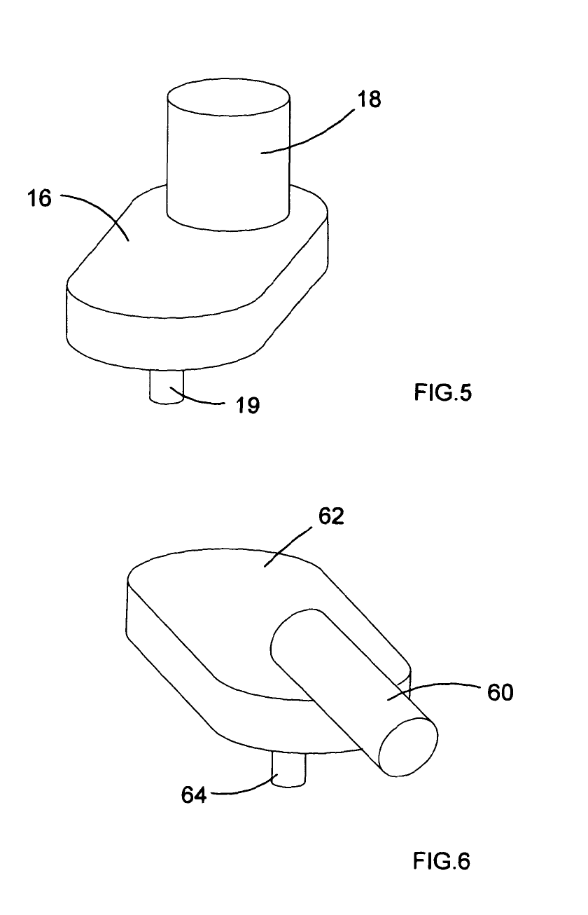

FIG. 5 is a perspective view of a motor and gearbox arrangement for driving a cleaning head; and

FIG. 6 is a perspective view of another motor and gearbox arrangement for driving a cleaning head.

### DETAILED DESCRIPTION OF EMBODIMENTS OF THE INVENTION

FIG. 1 shows a plan view of a cleaning machine. The cleaning machine has a preferred cleaning direction, as shown in FIG. 1.

The machine comprises a first drive head 10 and a second drive head 20. The first drive head 10 comprises a generally circular metal plate 12 having a lobe 14. A gearbox 16 is mounted above the metal plate 12, and a motor 18 is provided above the gearbox 16. The first drive head 10 is pivotally connected to a deck 2 at a pivot point 15 in the lobe 14 of the metal plate 12. The first drive head 10 comprises a rotary spindle (not shown) extending downwardly (in use) from its gearbox 16 through the deck 2. The rotary spindle is a mounting for a cleaning head and it is positioned at an arc radius R₁ relative to the pivot point 15.

The second drive head 20 also comprises a metal plate 22 having a generally circular part 23 and an extended lobe 24. A side lobe 27 extends outwardly from the extended lobe 24. A gearbox 26 is provided above the metal plate 22, and a motor 28 is provided above the gearbox 26. The second drive head 20 is pivotally connected to the deck 2 at pivot point 25 in the extended lobe 24 of the metal plate 22. The second drive head 10 comprises a rotary spindle (not shown) extending downwardly (in use) from its gearbox 26 through the deck 2. The rotary spindle is positioned at an arc radius R₂ relative to the pivot point 25. The arc radius R₂ of the rotary spindle of the second drive head 20 is greater than the arc radius R₁ of the rotary spindle of the first drive head 10.

The first and second drive heads 10, 20 are connected together with a link rod 30. The link rod 30 is pivotally connected to the metal plate 12 of the first drive head 10 at pivot point 32 which is beyond the arc radius R₁ of the rotary spindle. The link rod 30 is pivotally connected to the metal plate 22 of the second drive head 20 at the side lobe 27 which is within the arc radius R₂ of the rotary spindle.

The deck 2 is preferably cast from aluminium to provide a high structural rigidity. However, in alternative arrangements the deck could be made of plastic or fabricated steel sections.

The distance between the pivot point 15 and the pivot point 32 in the first drive head 10 is shown as D₁ in FIG. 1. The distance between the pivot point 25 and the pivot point 34 in the second cleaning head 20 is shown as D₂. D₁ is greater than D₂.

Referring to FIG. 1, the rotary spindle of each drive head 10, 20 is arranged for respective connection to a first cleaning head 40, 42. The first cleaning heads 40, 42 are circular and have brushes on their lower surfaces. The first cleaning heads 40, 42 have a diameter of 280 mm, and the cleaning width subtended by the machine is 550 mm in the configuration shown in FIG. 1 when the first cleaning heads 40, 42 are attached. The cleaning width is the combined span of the cleaning heads in a direction perpendicular to the cleaning direction. A slight overlap is provided between the cleaning spans of first cleaning heads 40, 42. This is possible because the axis of rotation of the spindle in the second drive head 20 is slightly in advance of that of the first drive head 10 with respect to the cleaning direction.

Arcuate slots (not shown) are provided in the deck 2 so that the spindles of the first and second drive heads 10, 20 can pivot together with the drive heads while extending through the deck 2. Further arcuate slots (not shown) are provided to guide the first and second drive heads 10, 20 while they pivot about their respective pivot points 15, 25.

A biased pin 48 is provided on the second drive head 20. The biased pin 48 is received by a detent (not shown) on the deck 2 so as to lock the second drive head 20 in position. The first drive head 10 is also locked in position when the biased pin 48 is received in the detent because the first and second drive heads 10, 20 are connected by the link rod 30.

In use the first and second drive heads 10, 20 are locked in position and the first cleaning heads 40, 42 are rotated by the motors 18, 28. When it is desired to change the cleaning width of the machine, the motors 18, 28 are shut off and the biased pin 48 is lifted from its detent in the deck 2 in order to unlock the first and second drive heads 10, 20. A user can then seize a portion of the second drive head 20 and swing it clockwise about the pivot point 25. The same effect may be achieved by seizing the first drive head 10 and swinging it counter clockwise about the pivot point 15, or seizing the link rod 30 and pushing it towards the cleaning direction (i.e. upwards in the plan view shown in FIG. 1).

The first and second drive heads 10, 20 are free to pivot when the biased pin 48 has been lifted from its detent. Under user action the first drive head 10 pivots counter clockwise about pivot point 15 and the second drive head 20 pivots clockwise about pivot point 25 in a linked movement until the biased pin 48 latches into another detent in the deck 2. This locks the first and second drive heads 10, 20 in new positions, as is shown in FIG. 2.

With the first and second drive heads 10, 20 in new positions the first cleaning heads 40, 42 are removed from their respective spindles, and second cleaning heads 50, 52 are attached. The second cleaning heads 50, 52 have a diameter of 330 mm, and the cleaning width subtended by the machine is 650 mm when the second cleaning heads 50, 52 are attached in the arrangement shown in FIG. 2. There is a slight overlap between the cleaning spans of the second cleaning heads 50, 52 in the arrangement of FIG. 2 because the spindle in the second drive head 20 is slightly in advance of the spindle in the first drive head 10 with respect to the cleaning direction. It will be appreciated that the cleaning width is increased by 100 mm when the machine is moved from the configuration shown in FIG. 1 to that of FIG. 2 and when the new cleaning heads are connected.

If it is desired to return to the configuration of FIG. 1 from the configuration of FIG. 2, the motors 18, 28 are shut off, the second cleaning heads 50, 52 are removed, the biased pin 48 is lifted, and the second drive head 20 is manually pivoted counter clockwise around the pivot 25 until the biased pin 48 latches into the detent. The first drive head 10 is pivoted clockwise about pivot 15 at the same time because its movement is linked to that of the second drive head 20 by the link rod 30. The first cleaning heads 40, 42 with a diameter of 280 mm are then re-attached to the spindles.

When the second drive head 20 is pivoted from its first configuration as shown in FIG. 1 to its second configuration as shown in FIG. 2, the position of its spindle translates towards the right (from the perspective of FIGS. 1 and 2) by approximately 75 mm with respect to the deck 2. In the same action the position of the drive spindle of the first drive head 10 translates towards the right by approximately 25 mm with respect to the deck 2. A relatively small translational movement of the spindle of the first drive head 10 causes a relatively large translational movement in the position of the spindle of the second drive head 20. This occurs for two reasons. First, the spindle of the second drive head is positioned with a larger arc radius from its pivot point 25 on the deck. Second, there is a mechanical advantage in the connection of the drive heads via the link rod 30, and a relatively small pivotal movement of the first drive head 10 causes a relatively large pivotal movement of the second drive head 20 because the distance D₁ is greater than the distance D₂.

While the present invention has been described with reference to two drive heads 10, 20, it would be quite possible to provide three or more drive heads. These drive heads could be linked together by a link rod having pivotal connections to each of the drive heads. In addition, while only two fixed positions for the drive heads 10, 20 have been described with reference to FIGS. 1 and 2, it would be possible to provide any number of fixed positions, and therefore any number of cleaning widths.

FIGS. 3 and 4 each show a plan view of a cleaning machine in a second embodiment of the invention. FIG. 3 shows the machine in a first configuration and FIG. 4 shows machine in a second configuration. The cleaning machine comprises a first drive head 110 and a second drive head 120 linked together by a link rod 130. The drive heads 110, 120 are mounted pivotally on an aluminium deck 102 in a similar manner to the first embodiment at pivot points 115 and 125 respectively.

A splash guard extends downwardly from the deck 102, in use, to surround the cleaning heads while they rotate. The splash guard includes a side cover 200 which is movable from a first configuration to a second configuration. The splash guard also includes a fixed component (not shown) that combines with the side cover 200 to surround the cleaning heads and prevent undesirable splashing.

The side cover 200 is pivotally mounted to the second drive head 120 at pivot point 202. The side cover 200 includes a first slot 204 which receives a first pin 206 that is mounted on the second drive head 120. The side cover 200 also includes a second slot 208 which receives a second pin 210 that is mounted on the aluminium deck 102. The first and second pins 206, 210 combine to guide the pivotal movement of the side cover 200 as it swings from the first configuration shown in FIG. 3 to the second configuration shown in FIG. 4.

When it is desired to change the cleaning width of the machine, a biased pin (not shown) is lifted and a user seizes and pulls the side cover 200 at location A. The second drive head 120 is swung clockwise about its pivot point on the deck 102 and the first drive head 110 is swung counter-clockwise about its pivot point. During the reconfiguration the side cover 200 pivots with respect to the second drive head 120, as guided by the first and second pins 206, 210 that slide in their respective slots 204 and 208. In this way the distance between the outside of the side cover 200 and the second cleaning head mounting 170 is adjusted from 145 mm (to suit a 280 mm brush) to 170 mm (to suit a 330 mm brush) when the mechanism is moved from the first to the second configuration.

The limits of the movement of the side cover 200 are defined by the lengths of the first and second slots 204, 206. In the first configuration the pins 206, 210 are at extreme ends of their respective slots 204, 208, and in the second configuration the pins are at the opposite extreme ends.

In the reconfiguration of the cleaning machine the second cleaning head mounting 170 translates horizontally further than the first cleaning head mounting 160 by a ratio of 3:1. This specific ratio is achieved by the arrangement of the link rod 130 and the selection of the arc radii of the first and second cleaning head mountings 160, 170 with respect to their pivot points on the deck 102.

FIG. 5 is a perspective view of the motor 18 and gearbox 16 shown in FIGS. 1 and 2. In use, the axis of rotation of the motor 18 is vertical. The rotation of the motor 18 is transferred to the spindle 19 by the gearbox 16.

FIG. 6 shows a perspective view of an alternative arrangement for a motor and gearbox. In use a motor 60 is provided with a horizontal axis of rotation. A gearbox 62 comprises a worm wheel (not shown) to transfer the rotation of the motor 60 to a spindle 64 which has a vertical axis of rotation in use.

1. A machine for cleaning a floor, comprising:
a deck for supporting at least two drive heads, wherein each drive head comprises a mounting for the attachment of an associated cleaning head and wherein the at least two drive heads are movable with respect to one another and with respect to the deck so as to permit relative movement of the drive heads from a first configuration in which the cleaning head mountings have a first spacing to a second configuration in which the cleaning head mountings have a second spacing; and
a link for connecting the drive heads in order to control relative movement of the drive heads, wherein a movement of one drive head with respect to the deck causes a movement, via the link, of at least one other drive head with respect to the deck, and wherein the movement of the drive heads effects movement of the cleaning head mountings from the first configuration to the second configuration.

2. A machine as claimed in claim 1 wherein each drive head is pivotal with respect to the deck.

3. A machine as claimed in claim 2 wherein the arc radius between a pivot point on the deck and the cleaning head mounting is different for at least two of the drive heads.

4. A machine as claimed in claim 2 wherein the link connects the at least two drive heads together such that a pivotal movement of one drive head causes a different magnitude of pivotal movement of another drive head.

5. A machine as claimed in claim 1 wherein the link is pivotally mounted on at least one of the drive heads.

6. A machine as claimed in claim 5 wherein each drive head is pivotally connected to the deck and the link is pivotally connected to each of the drive heads, and wherein the arc radius between the pivot point of the link on a drive head and the pivot point of the drive head on the deck is different for at least two of the drive heads.

7. A machine as claimed in claim 1 wherein the deck comprises a guide for guiding movement of a drive head with respect to the deck.

8. A machine as claimed in claim 1 wherein each drive head is releasably lockable in position relative to the deck.

9. A machine as claimed in claim 8 wherein each drive head is lockable in a plurality of discrete positions.

10. A machine as claimed in claim 8 further comprising a pin that is biased towards a detent in the deck or in at least one drive head such that the drive head is releasably locked in position when the pin is received in the detent.

11. A machine as claimed in claim 1 further comprising at least two cleaning heads, each cleaning head operatively connected to a respective drive head.

12. A machine as claimed in claim 1 wherein one drive head is provided in advance of another drive head with respect to the preferred direction of cleaning.

13. A machine as claimed in claim 1 wherein each drive head further comprises a motor and gear means for transferring the rotation of the motor to a rotatable spindle for connection to a cleaning head.

14. A machine as claimed in claim 1 further comprising an adjustable splash guard that is movable from a first configuration to a second configuration.

15. A machine as claimed in claim 14 wherein the adjustable splash guard is connected to at least one of the link and a drive head so that the splash guard is moved from its first configuration to its second configuration when the drive heads are moved with respect to the deck.

16. A machine as claimed in claim 14 wherein the splash guard is pivotally connected to a drive head.

17. A machine as claimed in claim 14 further comprising guide means on the deck arranged to guide the movement of the adjustable splash guard from its first configuration to its second configuration.

18. A method of operating a machine as claimed in claim 1 comprising the step of moving one drive head with respect to the deck to cause movement of at least one other drive head with respect to the deck so that the cleaning head mountings are moved from the first configuration to the second configuration.

19. A method as claimed in claim 18 further comprising the steps of
removing a first cleaning head from a drive head; and
attaching a second cleaning head to the drive head, wherein the second cleaning head and the first cleaning head have different diameters.
